(19) United States
(12) Patent Application Publication
(10) Pub. No.: US 2008/0005166 A1
(43) Pub. Date: Jan. 3, 2008

(54) DYNAMIC SEARCH RESULT OF AUDIO-VISUAL AND RELATED CONTENT

(75) Inventors: Brian J. Cragun, Rochester, MN (US); Paul R. Day, Rochester, MN (US); Gregory R. Hintermeister, Rochester, MN (US); Michael D. Rahn, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/427,542

(22) Filed: Jun. 29, 2006

(51) Int. Cl. G06F 7/00

(52) U.S. Cl. 707/104.1

(57) ABSTRACT

A method for dynamically searching of audio-visual and related content including: receiving an audio-visual content; displaying the audio-visual content to a user; obtaining one or more keywords from the audio-visual content; requesting an Internet search based on the keywords; receiving one or more search results responsive to the request for an Internet search; and providing the search results to the user.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

### Field of the Invention

The present invention relates to the field of dynamic searching systems. More specifically, the present invention relates to a method and apparatus for searching the audio-visual content and providing search results to a viewer of the audio-visual content.

### DESCRIPTION OF BACKGROUND

Currently, television viewers who desire to obtain more information about a television show, movie, or other audio-visual content may search for that information using a variety of sources, such as the Internet. One drawback is that users have to do the searching manually (e.g., select the keywords to search themselves). Often the users do not know enough information about the show (e.g., actors, producers, background, location, or the like) so their results have limited value. In a broad market where Web TV, Satellite, and Digital Video Recorders (DVRs) have made strides to provide a richer TV experience, users of these technologies still experience similar limitations. Additionally, current methods of search related advertisements selection and placement algorithms only utilize a currently displayed page to determine the advertisement to be displayed.

What is needed is a method for automatically performing dynamic searches of an audio-visual content in real-time without having to manually type in the proper keywords and providing the search results and related advertisements.

### SUMMARY OF THE INVENTION

Exemplary embodiments include a method for dynamically searching of audio-visual and related content including: receiving a audio-visual content; displaying the audio-visual content to a user; obtaining one or more keywords from the audio-visual content; requesting an Internet search based on the keywords; receiving one or more search results responsive to the request for an Internet search; and providing the search results to the user.

Exemplary embodiments also include a method for dynamically searching of audio-visual and related content including: receiving a audio-visual content, the audio-visual content includes a corresponding textual content; displaying the audio-visual content to a user; obtaining one or more keywords from the audio-visual content; obtaining a search term restriction from the user; retrieving a recent search history and incorporating the recent search history into the keywords; filtering the keywords responsive to the search term restriction; requesting an Internet search based on the keywords; receiving one or more search results responsive to the request for the Internet search; and providing the search results to the user, wherein the audio-visual content is a closed caption transcript of the audio-visual content.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which automatically performs dynamic searching of an audio-visual content in real-time without having to manually type in the proper keywords and provides the search results and related advertisements.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow chart of a method for dynamically searching of audio-visual and related content in accordance with exemplary embodiments;

FIG. 2 illustrates a block diagram for system for dynamically searching of audio-visual and related content in accordance with exemplary embodiments; and

FIG. 3 illustrates one example of a screen shot of a dynamic search system in accordance with exemplary embodiments.

The detailed description explains the preferred embodiments of the invention, together with advantages and features, by way of example with reference to the drawings.

### DETAILED DESCRIPTION OF THE INVENTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention in detail. The examples used herein are intended merely to facilitate an understanding of ways in which the invention may be practiced and to further enable those of skill in the art to practice the invention. Accordingly, the examples should not be construed as limiting the scope of the invention.

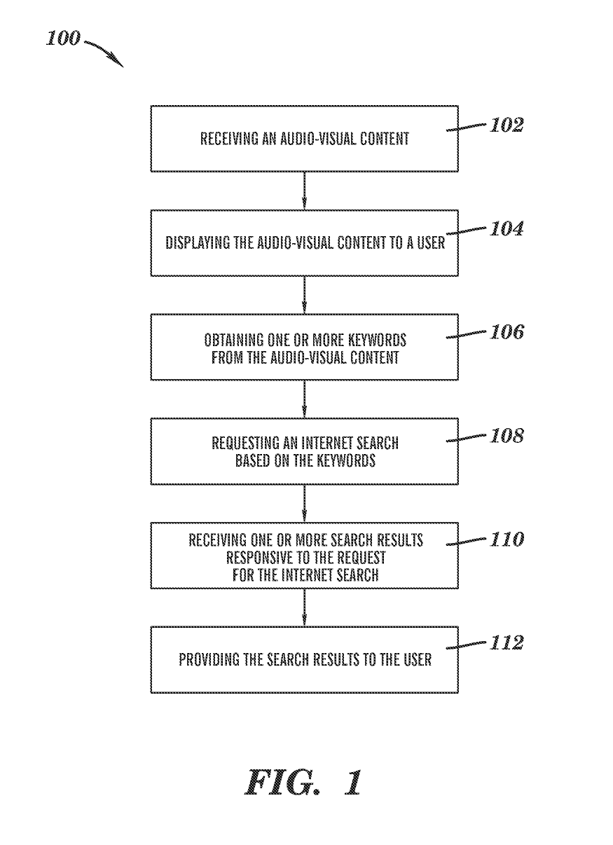

Referring now to FIG. 1, a flow chart of a method for dynamically searching of audio-visual and related content in accordance with exemplary embodiments is depicted generally as 100. The method 100 includes receiving an audio-visual content, as shown at process step 102, and displaying the audio-visual content to a user, as shown at process step 104. The method 100 also includes obtaining one or more keywords from the audio-visual content, as shown at process block 106. After obtaining the keywords from the audio-visual content, the method 100 proceeds to process step 108 and requests an Internet search based on the keywords. At process step 110, the method 100 receives one or more search results responsive to the request for the Internet search. After receiving the Internet search results, the method 100 provides the search results to the user, as shown at process step 112.

In one embodiment, the audio-visual content is a streaming video with closed caption text. The closed caption text is analyzed and selected keywords are selected for searching. For example, keywords selected from the displayed video are collected and passed to an advertisement selection server, which returns selected advertisements. The corresponding advertisements may be placed on a portion of the video display and may be displayed for a predetermined amount of time. For example, the keywords may include a persistence duration indicator that indicates the amount of time a keyword should be retained for use in searching. In one embodiment, during this time, the words for the displaying video are collected, and a new advertisement set is fetched and displayed, as the next set of words is collected. This time-based collection and harvesting of words places advertisements pertinent to the content of the video. In exemplary embodiments, the audio-visual content may not include a closed caption transcript and voice recognition software may be used to collect keywords for searching.

In another exemplary embodiment, recent search information may be combined with the keywords extracted from the audio-visual content. For example, suppose a user has been searching the Internet for memory sticks, it is obvious from this search that the user has a computer and uses a memory stick. The terms memory stick and computer may be added to the keywords used for the Internet search. In one embodiment, the use of recent search information may be based on a number of web sites visited, how often a specific site is visited, how long the user visited a site, whether the user purchased something from a site, or if the user explicitly clicked an option to remind him/her later of significant improvements to a product or special sales of the product. In exemplary embodiments, both the linear timing of the content as well as the search history of the user are used as parameters for the Internet search.

In one embodiment, an optional filter is provided to remove keywords that should never be presented as advertisements. The user may use a user preference system to store a list of terms that the user wishes to block from being used as keywords. In one example, a user who does not drink alcohol may not wish to see any advertisements or search results that relate to alcoholic beverages. Additionally, the user preferences system could also have default items of interest, which can be factored in when performing Internet searches. When the audio-visual content does not suggest any particular search words, the filter profile can provide general interest items.

In another embodiment, the user preference may include an option to notify the user when there is an advertisement or availability of a specific product, or when a product is advertised at or below a specified price. This option would be ideal for a user who wants to purchase a specific item and is willing to wait for the item to go on sale. Additionally, the user does not have to be watching television when the sale or advertisement comes on and instead can be notified the next time that he/she watches television. In another exemplary embodiment, the user may set a preference to be notified of the sale via email, SMS message, or other means, which is important if the sale or availability is for a limited time or limited supply.

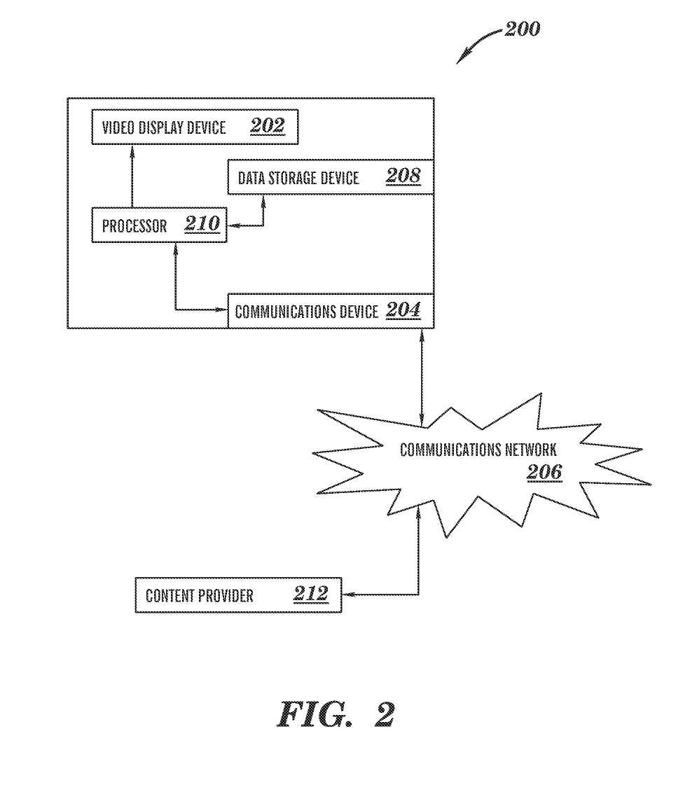

Referring now to FIG. 2, a block diagram for system for dynamically searching of audio-visual and related content in accordance with exemplary embodiments is illustrated generally as 200. The system 200 includes a video display device 202, a communications device 204, a communications network 206, a data storage device 208, a processor 210, and a content provider 212. The display device 202, the communications device 204, the data storage device 208, and the processor 210 may be combined into a single device or may be separated into one or more discrete devices. The communications device 204 is in operable communication with the communications network 206 and receives audio-visual content from the content provider 212. In one embodiment, the data storage device 208 may be used to store a user profile that includes user preferences as described above.

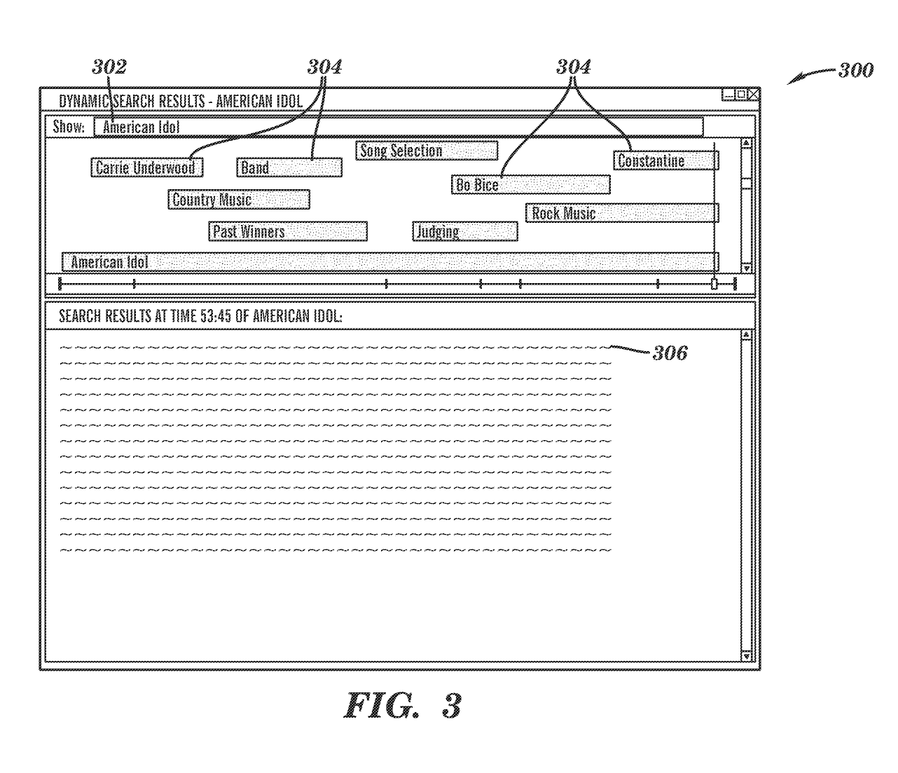

Referring now to FIG. 3, a screen shot of a dynamic search system in accordance with exemplary embodiments is illustrated generally as 300. The dynamic search system 300 includes an audio-visual content identifier 302, a plurality of keywords 304, and a plurality of search results 306. The audio-visual content identifier 302 may be a name of a television program, movie, or sporting event currently being displayed and the keywords 304.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for dynamically searching of audio-visual and related content comprising:
receiving an audio-visual content;
displaying the audio-visual content to a user;
obtaining one or more keywords from the audio-visual content;
requesting an Internet search based on the keywords;
receiving one or more search results responsive to the request for the Internet search; and
providing the search results to the user.

2. The method of claim 1, wherein the audio-visual content includes a corresponding textual content.

3. The method of claim 2, further comprising filtering the keywords prior to requesting the Internet search responsive to a user preference.

4. The method of claim 3, wherein the keywords are specified in the corresponding textual content.

5. The method of claim 4, wherein the corresponding textual content is a closed caption transcript of the audio-visual content.

6. The method of claim 3, further comprising receiving one or more advertisements responsive to the request for the Internet Search and providing the advertisements to the user.

7. The method of claim 6, wherein the keywords in the audio-visual content include a persistence duration indicator.

8. The method of claim 6, further comprising retrieving a recent search history and incorporating the recent search history into the keywords used for the Internet search.

9. A method for dynamically searching of audio-visual and related content comprising:
receiving a audio-visual content, the audio-visual content includes a corresponding textual content;
displaying the audio-visual content to a user;
obtaining one or more keywords from the audio-visual content;
obtaining a search term restriction from the user;
retrieving a recent search history and incorporating the recent search history into the keywords;
filtering the keywords responsive to the search term restriction;
requesting an Internet search based on the keywords;
receiving one or more search results responsive to the request for the Internet search; and
providing the search results to the user, wherein the audio-visual content is a closed caption transcript of the audio-visual content.
